(19) United States
(12) Patent Application Publication
(10) Pub. No.: US 2016/0216770 A1
(43) Pub. Date: Jul. 28, 2016

(54) METHOD AND SYSTEM FOR MOTION BASED INTERACTIVE SERVICE

(71) Applicant: Electronics and Telecommunications Research Institute, Daejeon (KR)

(72) Inventors: Min Su JANG, Daejeon (KR); Do Hyung KIM, Daejeon (KR); Jae Hong KIM, Daejeon (KR); Nam Shik PARK, Daejeon (KR); Mun Sung HAN, Daejeon (KR); Cheon Shu PARK, Daejeon (KR); Sung Woong SHIN, Daejeon (KR)

(21) Appl. No.: 14/663,188

(22) Filed: Mar. 19, 2015

(30) Foreign Application Priority Data
Jan. 28, 2015 (KR) 10-2015-0013277

(51) Int. Cl. G06F 3/01; G06K 9/00; G06F 3/03

(52) U.S. Cl. CPC G06F 3/017; G06F 3/0304; G06K 9/00369

(57) ABSTRACT

The present invention relates to a motion based interactive service method and system which provide various motion based interactive services such as repeated training of a motion, progressive difficulty adjustment, evaluation for every body part, and feedback based on the analysis result of the user's motion so that a user of a dance game or a dance lesson can efficiently perform a motion based performance or take a lesson by easy and various methods.

### CROSS-REFERENCE TO RELATED APPLICATIONS

This application claims priority to and the benefit of Korean Patent Application No. 10-2015-0013277 filed in the Korean Intellectual Property Office on Jan. 28, 2015, the entire contents of which are incorporated herein by reference.

### TECHNICAL FIELD

The present invention relates to a method and a system for providing an interactive service based on a motion of a user, and more particularly, to a method and a system for motion based interactive service which accurately detects a motion of a user input through a motion detecting sensor to represent the motion as information, compares the information with a reference database to evaluate and analyze a quality of spatial accuracy and temporal accuracy, and provides various user's motion based interactive services based on an analysis result.

### BACKGROUND ART

Various techniques of detecting and analyzing a motion of a human are developed in order to provide applications and services using a motion and a gesture. Such a motion information analysis and evaluation technique is utilized in various fields including human-machine interaction, a game, sports, rehabilitation, and arts.

During motion based games of the related art, a body motion is received as an image, and it is analyzed whether a user correctly copies a motion which is presented on a screen and the result is provided to the user as points. Such a method of the related art is appropriate for a game, but does not sufficiently provide a necessary function to a user who wants to more specifically learn the motion. For example, the related art does not provide detailed information for determining which part of the motion the user needs to be correctly performed. This is because the related art evaluates the motion of the user and represents the result with only a score or a level (for example, excellent, good, or nice). Therefore, the user does not specifically know which motion performed by a part of the body has a problem and what kind of problem occurs.

The related art does not provide a function of selecting a specific motion nor intensively learns the specific motion. In the case of a dancing game, since the user needs to learn the motion while dancing from the beginning to the end of a song, the user cannot select only a motion in which the user does not have confidence to repeatedly practice the motion. Many motions have movement, but the related art determines accuracy of the motion by only using information of a skeleton of a whole body such that the related art cannot properly read the movements. In the case of choreography, the movement is a very important factor to determine an accuracy of the choreography, so that a technique which considers the movement is required.

A system and a service method for entertainment based on a motion analysis have been developed. For example, in the dancing room, instead of singing a song, the user dances and gets points, which is different from karaoke. However, a basic configuration is similar to karaoke of the related art. Systems of the related art include various on-line services. There are a community service through which dancing by the user is recorded as a video to be shared and opinion is exchanged and a competition service through which the user competes the dance with a specified opponent in real time or measures the dance based on a point system with the opponent. The system and the service of the related art treat only the sharing of a simple video. In order to induce more active participation of the user, a unit which allows a user to generate, distribute, and share motion data by him/herself is required.

### SUMMARY OF THE INVENTION

The present invention has been made in an effort to provide a motion based interactive service method and system which provide various motion based interactive services such as repeated training of the motion, progressive difficulty adjustment, evaluation for every body part, and feedback based on the analysis result of the user's motion so that a user of a dance game or a dance lesson can enjoy a motion based performance or take a lesson through easy and various methods.

According to an aspect of the present invention, an interactive service method in a user motion based interactive service device for a repertory which is executed through a display screen, includes: executing a repertory which is selected by a user through a display screen so that sequential motions in accordance with reference motion data of the repertory data are displayed on the display screen and receiving a video and depth information of a motion of the user obtained by a motion detecting sensor to convert the video and the depth information into comparison target input data; extracting first skeleton data including an end point of a skeleton joint or a coordinate value for a joint or an angle of the skeleton joint for the motion of the user from the comparison target input data and comparing the first skeleton data with second skeleton data included in the reference motion data to evaluate a similarity of temporal or spatial consistency; and providing feedback of an evaluation result in accordance with the evaluation to the display screen.

The reference motion data may include repertory meta information, motion tracks as the reference motion data for one or more members which are displayed on the display screen, and a music track including music information.

For the repertory of selecting any one of the plurality members displayed on the display screen, the motion track may include a body part track including a coordinate value for an end point or a joint of a skeleton joint of the member or an angle of the skeleton joint and a meta information track including a name of a motion for every time period, importance of the motion, importance for every body part, or difficulty of the motion.

The providing of feedback may include providing feedback by dividing the evaluation result in accordance with a similarity for temporal or spatial consistency for every body part with the reference motion data for a motion of the user and display the result on the display screen in accordance with a divided displaying method or provide the feedback of the result by a voice through a speaker.

The providing of feedback may include overlapping the motion of the user on a character which performs the reference motion in accordance with the reference motion data as silhouettes to display the motion of the user on the display screen.

The providing of feedback may include dividing the motion of the user in accordance with a level of the similarity for every unit of motion to display the motion in different regions of the display screen by an icon.

The interactive service method may further include: analyzing the reference motion data, and displaying, on the display screen, a motion configuring map which represents a section of a sequential time line structure for every unit of motion, motion track meta information including a fluctuation graph which represents importance for every motion section represented on the motion configuring map, and a set of icons which are selected by the user so as to display the summarized information for every motion section and enable a game or a lesson for every motion section.

The interactive service method may further include: calculating the calorie consumption in accordance with the similarity in accordance with the motion of the user using biomechanics information included in the repertory data and displaying the calorie consumption for the motion of the user on the display screen.

The repertory data may be managed and provided by the interactive service device, or provided through a server on a network which receives the repertory data through an external game/lesson publishing device on-line, or a motion performing result in accordance with the game or the lesson for the repertory of users may be provided to the server as a personal profile and then provided by the server on-line.

According to another aspect of the present invention, an interactive service system in a user motion based interactive service for a repertory which is executed through a display screen, includes: a game/lesson manager which executes a sequential motion in accordance with reference motion data of repertory data for a repertory selected by a user through a display screen to be displayed on the display screen; and a video processing manager which receives a video and depth information for a motion of the user obtained by a motion detecting sensor and converts the video and the depth information into comparison target input data, in which the game/lesson manager extracts first skeleton data including an end point of a skeleton joint or a coordinate value for a joint or an angle of the skeleton joint for the motion of the user from the comparison target input data and compares the first skeleton data with second skeleton data included in the reference motion data to evaluate a similarity of temporal or spatial consistency; and provides feedback of the evaluation result in accordance with the evaluation to the display screen.

The reference motion data may include repertory meta information, motion tracks as the reference motion data for one or more members which are displayed on the display screen, and a music track including music information.

For the repertory of selecting any one of the plurality members displayed on the display screen, the motion track may include a body part track including a coordinate value for an end point or a joint of a skeleton joint of the member or an angle of the skeleton joint and a meta information track including a name of a motion for every time period, importance of the motion, importance for every body part, or difficulty of the motion.

The game/lesson manager may provide feedback by dividing the evaluation result in accordance with a similarity for temporal or spatial consistency for every body part with the reference motion data for a motion of the user and display the result on the display screen in accordance with a divided displaying method or provide feedback by a voice through a speaker.

The game/lesson manager may overlap the motion of the user on a character which performs the reference motion in accordance with the reference motion data as silhouettes to be displayed on the display screen.

The game/lesson manager may divide the motion of the user in accordance with a level of the similarity for every unit of motion to display the motion in different regions of the display screen by an icon.

The game/lesson manager may analyze the reference motion data and display, on the display screen, a motion configuring map which represents a section of a sequential time line structure for every unit of motion, motion track meta information including a fluctuation graph which represents importance for every motion section represented on the motion configuring map, or a set of icons which are selected by the user so as to display the summarized information for every motion section and enable a game or a lesson for every motion section.

The game/lesson manager may calculate the calorie consumption in accordance with the similarity in accordance with the motion of the user using biomechanics information included in the repertory data and display the calorie consumption for the motion of the user on the display screen.

The repertory data may be managed and provided by the interactive service device, or provided through a server on a network which receives the repertory data through an external game/lesson publishing device on-line, or a motion performing result in accordance with the game or the lesson for the repertory of the users may be provided to the server as a personal profile and then provided by the server on-line.

According to the motion based interactive service method and system according to the present invention, the user may easily and efficiently enjoy the motion based performance or take a lesson by various methods such as a dance game or dance lesson. Therefore, a new service industry such as a dance practicing center through the online network is created and users create, share, and distribute various motion data of the users so that it is expected that an additional market is formed.

Applications or services of the related art does not provide a method of selecting a motion and taking a lesson, but according to the present invention, the user easily selects the motion and takes a lesson. For example, in dance games of the related art, when the user selects a song, the user dances the choreographic motion while playing the song from the start to the end and then total score is provided. In contrast, according to the present invention, when the user wants, the user may select and play a part of the entire choreography which configures the song and take a lesson while playing only a part of a body part.

Also in the motion recognition based games of the related art, a method of evaluating a quality of the motion performed by the user is included and a unit which provides a lesson for the motion to the user based on the method is provided, but in the method of the related art, the lesson procedure is simple and feedback for the user's motion is not sufficient, so that the efficiency of the lesson is lowered. In contrast, the present invention suggests a method of efficiently and specifically provides a lesson of a complex motion by improving a feedback method, a lesson procedure management, and an interaction interface configuration.

A choreographic motion evaluating method in which positional movement accompanied with the choreography according to the present invention is considered may cope with change of a formation of a group dance performed by a plurality of members, so that more various choreographies are accepted to provide various interactive services.

A database including biomechanics information according to the present invention is utilized, so that the calorie consumption of the user is more precisely predicted and the database is utilized for the health management of the user.

According to the present invention, performance data such as choreography is supplied and distributed through the online server, so that the information is shared and participation of the users is more actively induced.

### BRIEF DESCRIPTION OF THE DRAWINGS

FIG. 1 is a view explaining a motion based interactive service system according to an exemplary embodiment of the present invention.

FIG. 2 is a flowchart explaining an operation of a motion based interactive service system according to an exemplary embodiment of the present invention.

FIG. 3 is a view explaining repertory data according to an exemplary embodiment of the present invention.

FIG. 4 is a view explaining an evaluation result feedback method of a motion of a user through a display device according to an exemplary embodiment of the present invention.

FIG. 5 is a view explaining a selective lesson method through a display device according to an exemplary embodiment of the present invention.

FIG. 6 is a view explaining an example of an implementing method of a motion based interactive service system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, the present invention will be described in detail with reference to accompanying drawings. In this case, like components are denoted by like reference numerals in the drawings as much as possible. Further, a detailed description of a function and/or a configuration which has been already known will be omitted. In the following description, parts which are required to understand an operation according to various exemplary embodiments will be mainly described and a description on components which may cloud a gist of the description will be omitted. Some components of the drawings will be exaggerated, omitted, or schematically illustrated. However, a size of the component does not completely reflect an actual size and thus the description is not limited by a relative size or interval of the components illustrated in the drawings.

The present invention is related with a method of acquiring information of a whole body motion of a user using a motion detecting sensor such as an image sensor which may detect a depth and analyzing the information to evaluate a quality of a motion of a user.

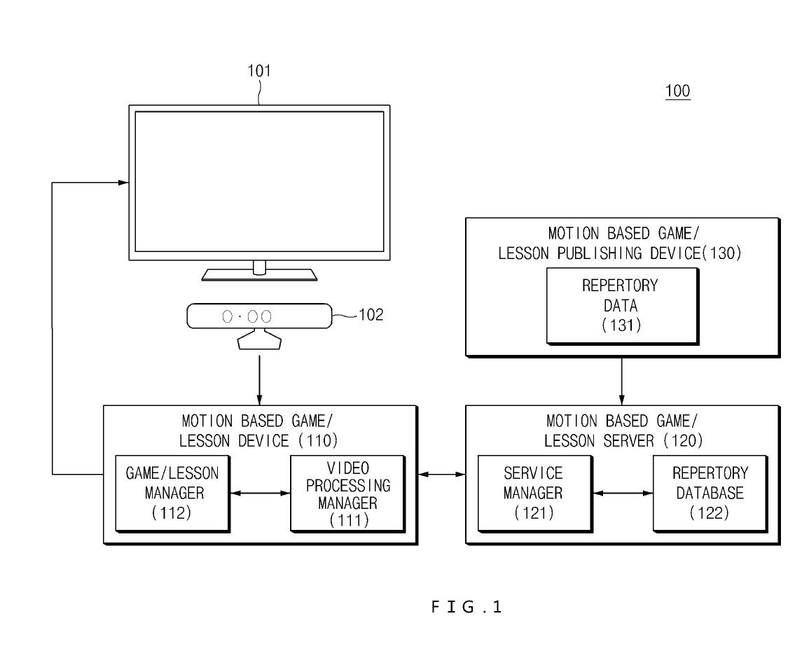

FIG. 1 is a view explaining a motion based interactive service system 100 according to an exemplary embodiment of the present invention.

Referring to FIG. 1, the motion based interactive service system 100 according to an exemplary embodiment of the present invention may include a display device 101 such as an LCD, a motion detecting sensor 102 which includes a digital camera and a depth camera, a motion based game/lesson device 110 including a video processing manager 111 and a game/lesson manager 112, a motion based game/lesson server 120 including a service manager 121 and a repertory database 122, and a motion based game/lesson publishing device 130 which manages repertory data 131 to be provided and distributed.

The display device 101 displays a motion based game of the exemplary embodiment, details of the lesson, and a process thereof and the motion detecting sensor 102 obtains a video including the whole body for the user's motion and depth information (for example, coordinate for every pixel (x, y, z)) through various imaging units such as a digital camera or a depth camera and sensors. The user may participate in the game or the lesson process as guided by the motion based game/lesson device 110 after the motion detecting sensor 101 is located in a space within a detectable range.

The motion based game/lesson device 110, the motion based game/lesson server 120, and the motion based game/lesson publishing device 130 interwork with each other through a network such as a wired/wireless Internet, a mobile communication network, or a local area network LAN.

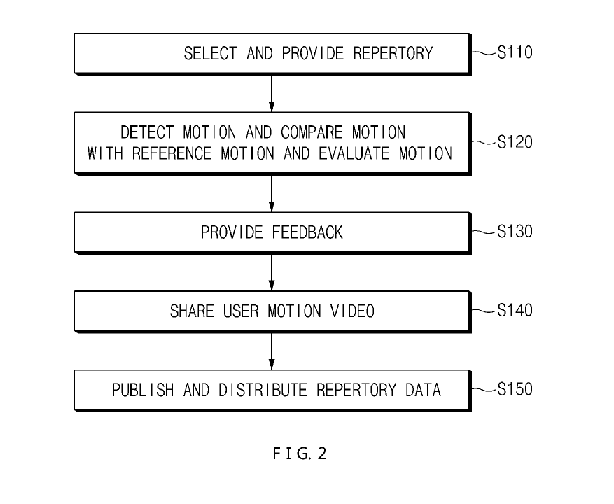

Hereinafter, an operation of the motion based interactive service system 100 according to an exemplary embodiment of the present invention will be described in detail with reference to the flow chart of FIG. 2.

The user first may select one of various repertory lists which are displayed on a screen of the display device 101 by the game/lesson manager 112 of the motion based game/lesson device 1101 to receive the repertory through the display device 101 in step S110. When a plurality of motion executing members is displayed on the display device 101, any one of the members may be selected. As a selecting unit, various input devices such as a remote controller, a mouse, an infrared pointer, and a touch screen may be used. Some of the repertories is stored in an internal storage of the motion based game/lesson device 110 to be provided when it is requested or stored in an internal storage of the motion based game/lesson server 120 which is a remote server to be provided when it is requested. For example, in the case of the dance game, one repertory is configured by choreographic motion data (reference motion data), music, and meta information. When the repertory selected by the user is stored in the motion based game/lesson server 120, the motion based game/lesson device 110 requests data to the service manager 121 of the motion based game/lesson server 120 to obtain, provide, and utilize repertory data including the reference motion data. In the repertory database 122, a set of choreographic motion data (reference motion data) for evaluating a quality of the user's motion, music information, and meta information are stored and managed. For example, in the case of a dance game, the reference motion data is choreographic motion data obtained when a professional dancer dances in accordance with choreography of the original music.

As the user's motion is similar to the reference motion, the user's motion is graded with a higher score by the game/lesson manager 112. When the repertory data is transmitted to the motion based game/lesson device 110 and stored, and then starts to be executed, music included in the repertory data and a series of motions in accordance with the reference motion data are sequentially displayed on the screen. The user copies the motion while watching the reference motion displayed on the screen. The video for the motion of the user and depth information are obtained by the motion detecting sensor 102 and the video processing manager 111 processes the video for the motion of the user and the depth information received from the motion detecting sensor 102 with comparison target input data to be appropriately processed in the device 110 through a predetermined conversion method or an encoding method and transmits the video and the information to the game/lesson manager 112. The game/lesson manager 112 compares and analyzes the reference motion with the user's motion and evaluates a quality, based on the comparison of the comparison target input data for the image for the user's motion and the depth information with the reference motion data in step S120.

The game/lesson manager 112 may feedback the evaluation result described above to the user through the display device 101 in step S130. The evaluation of the motion is performed in the unit of predetermined time intervals to be provided to the user in real time and the total score obtained by collecting evaluation results for every section after the music of the repertory ends may be provided to the user. A length of the time section where the motion evaluation is performed may be determined by the meta information included in the repertory data. When there is no meta information, the length may be arbitrarily determined by a motion recognizing technique to be an appropriate length.

The motion based game/lesson server 120 includes the repertory database 112 which stores and manages repertory data required to provide the motion based game/lesson service and the service manager 121 which manages the service. In the repertory database 122, a large quantity of repertory data which may be selected by the user is stored and managed. The service manager 121 serves to receive a request from the motion based game/lesson device 110 to search and extract the repertory data from the database 122 and then transmit the repertory data to the motion based game/lesson device 110. Further, the service manager 121 provides various on-line services to manage rankings between users and share a video (for example, including video for the motion of the user and depth information or the evaluation result) of the user's motion on the internet.

The motion based game/lesson publishing device 130 is a collective term for a device and software which perform a function of generating repertory data. The motion based game/lesson publishing device 130 which is a writing device may publish (provide) the repertory data 131 which is generated by capturing a motion of a professional dancer through various equipment such as a visual marker or an inertial sensor suit and editing the motion through various software to various servers on the internet such as the motion based game/lesson server 120 through the network connection 132 in step S150. The motion based game/lesson server 120 interworks with a plurality of motion based game/lesson devices 110 through the network connection to request and distributes the data. The motion (result) data of the user which is provided from the game/lesson manager 112 and the repertory data which is generated by the user through the support of the game/lesson manager 112 are provided to the motion based game/lesson server 120 to be distributed on online.

As described above, the repertory data includes the reference motion data which may evaluate the quality of the user's motion and is also utilized as reference data to evaluate the quality of the user's motion. In the exemplary embodiment of the present invention, the motion data is represented by an end point of a skeleton of arms, legs, and head which configure the whole human body, a coordinate of an intersecting point of joints, or an angle of a joint of the skeleton. The game/lesson manager 112 analyzes the video and the depth information for the motion of the user which are obtained through the sensor 102 to extract skeleton data (for example, the end point of the skeleton joint or a coordinate value corresponding to the joint, or the angle of the skeleton joint) with the same format as the reference motion data and calculates a similarity to the reference motion data, thereby determining the quality of the user's motion. That is, the quality of the motion depends on how much the user's motion is similar to the reference data. Various spatial or temporal methods to determine the similarity between motions have been already disclosed in various documents, so that the methods are not included in the scope of the present invention. However, a data structure which may represent reference motion data having various configurations will be suggested.

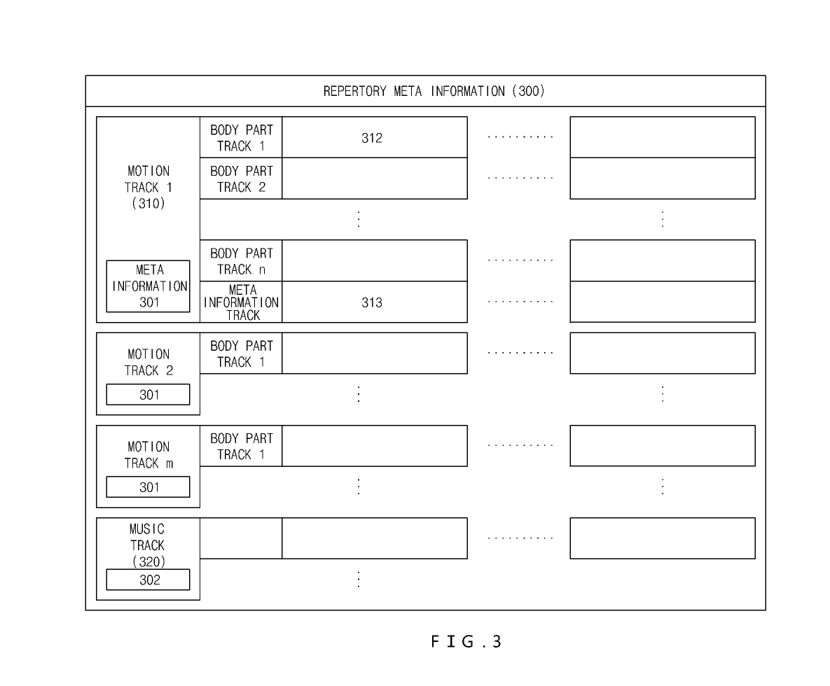

FIG. 3 is a view explaining repertory data according to an exemplary embodiment of the present invention. As illustrated in FIG. 3, the repertory data according to the exemplary embodiment of the present invention includes repertory meta information 300, a plurality of motion tracks 1, 2, . . . , m 310 as the reference motion data, and a music track 320 as the music information.

The repertory meta information 300 includes information such as a title, a producer, a copyright holder, an identification number, or a keyword. The repertory meta information 300 may also be utilized to search for a repertory.

The music track 320 is a track in which music information which is synchronized with the motion track 310 is recorded. The music track 320 may include a meta information 302 structure including the names of the members such as a singer who sings the song or a composer.

The plurality of motion tracks (1, 2, . . . , m) 310 corresponds to each of the motion executing members which are displayed on the display device 101. For example, a dance repertory in which three persons dance may include three motion tracks. Each motion track 310 may include the meta information 301 structure including a name of a member who is responsible for the track.

The plurality of motion tracks (1, 2, . . . , m) 310 may include a plurality of body part tracks 312 and meta information tracks 313, respectively. Each body part track 312 is a track for skeleton data such as an end point (a terminal of the body) of the skeleton joint such as the arms, the legs, and the head which configure the body, a three-dimensional coordinate value corresponding to the joint such as the knee, elbow, or neck or an angle of the skeleton joint. Data for the three-dimensional coordinate value of the body part track 312 may be detected and recorded at a predetermined level or higher of sampling period by a method such as motion capture. The meta information track 313 is a track which records various information required to proceed and a lesson of the motion based game for every time interval of the motion track and may include information such as a name of a motion for every time interval, importance of the motion, importance of the body parts, and difficulty of the motion.

For example, as an exemplary embodiment, the repertory data corresponds to a song which is sung by a dance group having three members and the video thereof. The repertory data may include one music track 320 containing songs and three motion tracks 310 including choreographies of three members of a dance group. Meta information 301 including a name of a member who performs the choreography is added to each motion track 310. When the choreographies of three members are equal to each other, only one motion track 310 is maintained and all information on three members may be recorded in the meta information 301. In a meta information track 313 which is included in each of the motion tracks 310, a title of the choreography and importance for every essential body part may be recorded for every primary time interval.

The motion based game/lesson device 110 determines a quality of the user's motion based on a similarity between the user motion data and the reference motion data. Various similarity measuring methods in which spatial and temporal characteristics and restriction of the motion are considered have been suggested. According to these methods, the similarity between two motions is evaluated from both aspects of temporal consistency and spatial consistency and this evaluation may be performed for every body part such as arm, leg, and head. Further, a method of assigning a higher weight to a part which is more important to perform the motion, among the body parts and a method of assigning a higher weight to a more important motion among a series of unit motions have been suggested. Specific description of the similarity calculating method between motions is omitted and the similarity calculation between motions of the related art may be utilized in this exemplary embodiment.

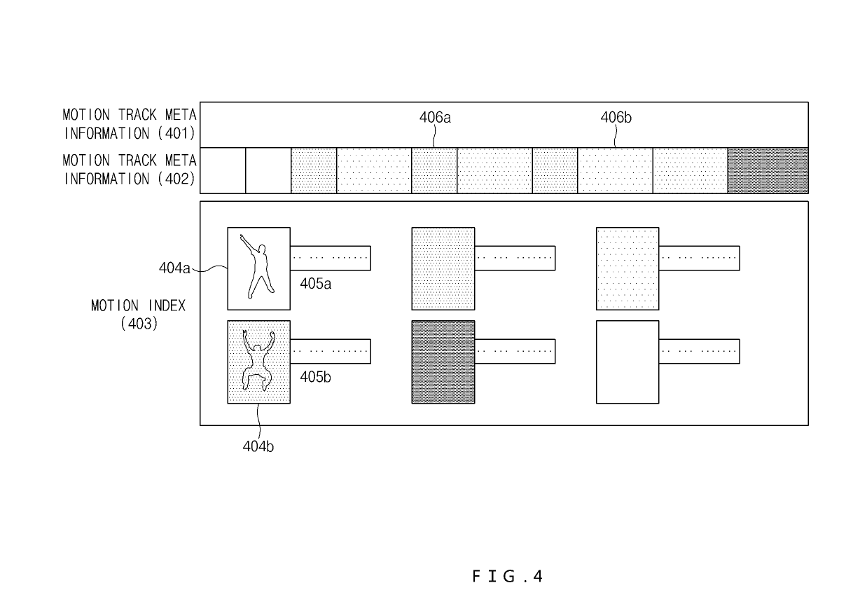

FIG. 4 is a view explaining an evaluation result feedback method of a motion of a user through the display device 101 according to an exemplary embodiment of the present invention.

The game/lesson manager 112 of the motion based game/lesson device 110 feeds various information back through the display device 101 in accordance with the user motion evaluation result in real time so as to help the user correct the motion and easily perform with a correct motion.

In the exemplary embodiment of the present invention, the game/lesson manager 112 of the motion based game/lesson device 110 checks the temporal consistency between the user's motion and the reference motion to determine whether the user performs the motion faster or slower than the reference motion and visualizes the determination for every body part to provide the visualized determination to the user through the display device 101. A body part which performs the motion at an appropriate speed and a body part (or a skeleton) which performs the motion at a high speed and a body part which performs the motion at a low speed are divided and the body parts of a character which are displayed on the screen are may be provided with color by various methods.

As illustrated in FIG. 3, not only contours or silhouettes 202a and 202b for the user's motion are displayed, but also a body part which performs a high speed motion is displayed with a reddish color (203b) and the body part which performs a low speed motion is displayed with a bluish color (203a). In this case, the color concentration is adjusted to display how much slower or faster than the reference motion (temporal consistency feedback). The user checks the color information to easily adjust his/her own motion to the reference motion. The spatial consistency may also be fed back using different colors. For example, as for a degree (spatial consistency) at which a trace of the motion which matches the reference motion for every body part, the spatial consistency may be displayed on the screen using a color which is different from the color utilized in feedback of the temporal consistency. Such a visualizing method for every body part is not limited to a method using a color but the same effect may be achieved by displaying arrows, other various icons or character strings on the screen.

In another exemplary embodiment of the present invention, the motion based game/lesson device 110 may feedback a motion performing state of the user using a voice through a speaker of the display device 101 or a separate speaker. The voice feedback may be easily understood by the user and has an advantage in that feedback information may be obtained even in a state when the user cannot watch the screen in some motions. The voice feedback is representatively configured by a name of the body part and a state thereof. For example, the feedback may be “a left arm is slow” or “a right foot is very fast”. Specific way of speaking and a length of a sentence may vary in accordance with a speed of the song and a taste of a content creator.

The voice feedback may be configured by the name of the body part and a goal of the user's motion. For example, “move the left foot faster” or “move the right foot slower”. Such a voice feedback method may be performed not only for the speed of the motion, but also for the spatial characteristic of the motion. For example, “raise the left arm higher” or “spread the legs more”.

In another exemplary embodiment of the present invention, the game/lesson manager 112 of the motion based game/lesson device 110 may generate a silhouette of a human using user's skeleton information as illustrated in 202c of FIG. 3 and display the silhouette on a character who performs the reference motion on the screen of the display device 101 to overlap each other by various methods. The user visually and easily compares his/her own motion with the reference motion, so that the motion may be efficiently corrected and acquired. When both of the entire body silhouettes overlap, lengths of the body parts of the user and the character are different from each other so that it may be difficult to naturally overlap the body silhouettes, but the sizes of the user and the character may be approximately adjusted. The length of the skeleton joint of the user is modified to be similar to a body structure of the character, so that the outer appearance of the character is well adjusted to the whole body silhouette of the user. In the field of motion capture and animation, a retargeting technique which is utilized for this purpose may be utilized to overlap the silhouettes according to the exemplary embodiment.

In another exemplary embodiment of the present invention, the game/lesson manager 112 of the motion based game/lesson device 110 may display a result of evaluating the user's motion on a screen in a unit of motion having a predetermined length of time. For example, a motion which is performed well by the user with accuracy (a similarity) which is equal to or higher than a threshold value is displayed by an icon 211a in a predetermined region 211 of the screen. Similarly, a motion which is insufficiently performed by the user with a low accuracy is also displayed by icons 210a and 210b in another region 210 of the screen. In this case, a point of accuracy of the motion for every body part is reflected, so that a color or a displayed position may vary depending on the body part as illustrated with reference numerals 210a and 210b.

The user's silhouette in the icons 210a, 210b, and 211a may move in accordance with the reference motion data of the motion. When the game/lesson using the selected repertory data ends, the user may check a motion which is satisfactorily performed and a motion which is unsatisfactorily performed through the screen and select an icon to receive a screen for a lesson to take a lesson on a screen for the motions which are unsatisfactorily performed from the game/lesson manager 112 to practice the motions.

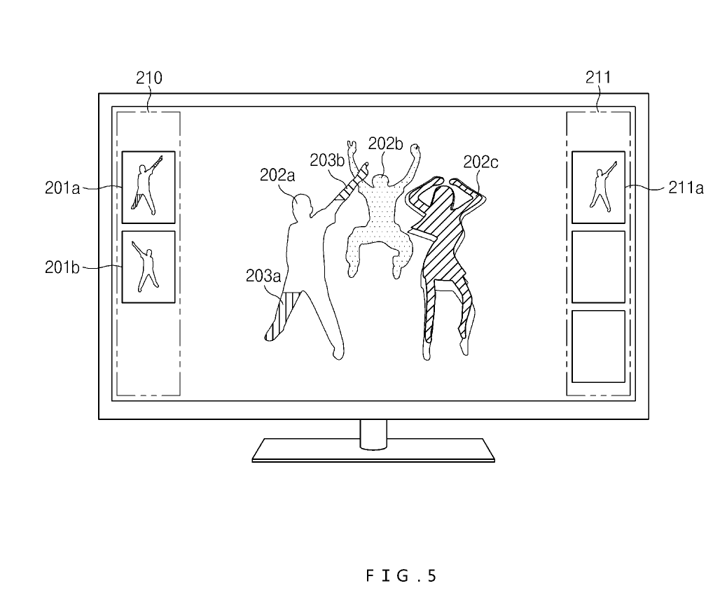

FIG. 5 is a view explaining a selective lesson method through a display device 101 according to an exemplary embodiment of the present invention.

The game/lesson manager 112 of the motion based game/lesson device 110 may provide a motion browsing and selecting method which allows the user to easily browse and select the contents of the motion track of the repertory data as illustrated in FIG. 5. In an exemplary embodiment of the present invention, the game/lesson manager 112 processes the repertory data (or the reference motion data) selected by the user to display motion track meta information 401, a motion configuring map 402, and a motion index 403 on a screen of the display device 101 in accordance with the analysis result as illustrated in FIG. 5.

First, the motion configuring map 402 is configured based on contents of the body part track 312 included in the motion track 310 corresponding to a performing member selected by the user. The motion configuring map 402 may be displayed as a time line structure in which a configuration of a sequential motion from the beginning of the motion track 310 to the ending is divided into several sections. Each section corresponds to one divided unit of a choreographic motion. For example, in the case of a song including choreography included in a dance game, the motion configuring map 402 includes a plurality of choreographic motions and the sections are divided in accordance with the choreographic motion based on a progress of the song. A length of each section varies depending on a duration of the choreographic motion. Further, in each section of the motion configuring map 402, sections including different choreographic motions are visually distinguished and sections including the same choreographic motion are displayed to be visually seen with the same pattern such as a color.

The motion track meta information 401 is configured based on information written in the meta information track 313 (for example, a name of a motion for every time period, importance of the motion, importance of every body part, and a difficulty of the motion). In the exemplary embodiment of the present invention, the motion track meta information 401 may include a fluctuation graph (not illustrated) representing the importance for every motion section displayed on the motion configuring map 402. Further, the motion track meta information may include a name of a major motion. The user may understand the motion track configuration of the entire repertory data at a glance from the motion configuring map 402 and the motion track meta information 401.

The motion index 403 may be configured by sets 404a and 404b of icons which represents summarized information for the motion section like a displaying method for every section (for example, a section including the same choreographic motion) used for the motion configuring map 402. In the exemplary embodiment of the present invention, a background screen of each of the icons may be provided with the same color as a color used to distinguish the motions in the motion configuring map 402. In this case, the motion which needs to be performed in the section may be represented by a small character icon. The character icon visualizes the motion of the section in various ways and may be a moving icon using reference motion data included in the time section of the motion track included in the repertory data or a video of the motion which is actually performed by the dancer. Each icon may be displayed together with explanation windows 405a and 405b including additional explanation. The explanation windows may include meta information such as the name of the motion or a concerned body part. The user may select one or several motions included in the motion index 403 by pointing using a hand gesture or a scroll function which is provided from a motion based game interface of the related art. When the repertory data includes two or more motion tracks 310, the game/lesson manager 112 may generate the motion track meta information 401, the motion configuring map 402, and the motion index 403 with reference to the meta information track 313 of each track 310 and display all icons including the characters in the motion indexes 403, on the screen. The user selects a desired character or icon among them and performs the game or lesson in accordance with the motion track 310 corresponding to the selected character or icon. As described above, when the user selects a game or lesson function after selecting a motion to take a lesson, the game/lesson manager 112 reproduces the selected motion in accordance with the order and the user copies the motion. In this case, as illustrated in FIG. 4, the motion quality evaluation and the feedback are performed.

In the exemplary embodiment of the present invention, when the user selects several icons of the motion index 403 for the motion to take a lesson, the game/lesson manager 112 sequentially presents the motions to the user to allow the user to practice the motion and provides the screen to the user to allow the user to repeat the motion until the user performs the motions to get a predetermined level or higher of accuracy. One motion is repeatedly reproduced to allow the user to practice the motion and then when the accuracy of the motion exceeds a predetermined threshold value, the next motion is then shown. However, when the accuracy of the motion of the user is not improved after a predetermined maximum number of repetition, the motion is abandoned and the next motion is shown. In this case, the game/lesson manager 112 may store the abandoned motion as a motion which needs to be continuously practiced by the user in a predetermined storage unit as a personal profile.

In the exemplary embodiment of the present invention, the user designates the beginning and the ending of a partial section of the entire section of the repertory data 131 and takes a lesson only for the section. The game/lesson manager 112 may display a window which allows the user to easily select the beginning and the ending while performing the motion on the screen of FIG. 5 to smoothly perform the interaction. For example, the user selects two of the sections represented on the motion configuring map 402 to designate the starting 406a and the ending 406b of the section 406. A starting time of a section 406a at the left among the two sections selected from the motion configuring map 402 on the screen becomes a starting time of the section and the ending time of the section 406b at the right becomes an ending time of the section. The user points a specific point of the screen using a device such as a mouse or an infrared pointer to select the section. Alternatively, in a touch screen method, the user points the screen by using a hand to select the section.

When the section is designated, the game/lesson manager 112 provides a menu to execute a section play on the screen to support the user to select the menu. A menu to repeatedly play the section is also provided on the screen. Alternatively, the game/lesson manager 112 may infinitely repeat the designated section until a specific event occurs. For example, when the user stops for two seconds or longer without performing any motion, the game/lesson manager 112 recognizes this in accordance with video and depth information and determines that the user does not want to repeat the section and stops the section repeating play.

In the exemplary embodiment of the present invention, the game/lesson manager 112 may recognize a gesture command of the user to represent the beginning and the ending of the section. The user may start the repertory and normally performs the motion, or waits without performing a motion until a desired point of time. When it is a point of time which is desired to be set as the beginning of the section, the user stops performing the motion and then gestures to display the beginning of the section so that the game/lesson manager 112 recognizes the section start indicating gesture and records the section starting time. Similarly, the user waits till the section ending time, and then gestures to display the end of the section, and the game/lesson manager 112 recognizes the gesture and records the section ending time. When the section designation is completed, menus (for example, section play, repeated play) for section play are provided.

In the exemplary embodiment of the present invention, a voice command may be utilized to designate a section. A voice signal for representing the beginning time of the section and the ending time of the section is registered in advance and the game/lesson manager 112 recognizes a voice signal (for example, a name of a section, time, and a name of an icon) received through a microphone (not illustrated) to recognize the beginning time and the ending time of the section. The repertory generally includes a music track. However, since the game/lesson manager 112 holds voice information of the music track, a technique such as echo cancelling is mobilized, so that the voice command of the user to designate a section may be easily recognized.

In the exemplary embodiment of the present invention, the user may select only a part of a body part to practice a motion. To this end, the game/lesson manager 112 may evaluate accuracy only for the body part which is selected by the user and provide feedback. Various methods may be used to select the body part. For example, the game/lesson manager 112 displays a silhouette of an entire body of the user on a screen as illustrated in FIG. 5 and the user indicates a desired body part through screen pointing (for example, a mouse, voice, a gesture, and a pointer) to select the desired part. Alternatively, in another exemplary embodiment, the game/lesson manager 112 displays the silhouette of the entire body of the human on the screen and then sequentially highlights the body parts at a predetermined time interval. When the desired body part is highlighted, the user may select the highlighted part through a command such as a mouse, a voice, a gesture, and a pointer.

In the exemplary embodiment of the present invention, the user may adjust a proceeding speed of the repertory to practice a motion. This function is a function to assist the user to slowly practice a complex motion which is not familiar to the user to easily perform the motion. The proceeding speed may be set when all game play and lesson functions such as the entire repertory play, section play, and lesson to select a motion body part are performed. The game/lesson manager 112 may provide a menu to select the proceeding speed before starting the game or lesson in various situations. One of the values which are divided into several levels (very fast, fast, normal, slow, very slow) is selected as the speed and the desired speed is selected through an interface such as a dial or a scroll bar. As the speed, beats per minute (BPM) which designates the speed of music may be applied.

In the exemplary embodiment of the present invention, the game/lesson manager 112 may actively adjust the proceeding speed of the repertory in accordance with the motion speed of the user. First, the user may select an executing mode in which the game/lesson manager 112 actively adjusts the proceeding speed of the repertory through a menu provided on the screen by the game/lesson manager 112. According to the selected proceeding speed mode, the user may intentionally slow down the speed in order to precisely perform the motion in a motion section which is not used. Since the game/lesson manager 112 consistently evaluates a temporal consistency between the user's motion and the reference motion, the motion speed of the user may be inferred. The game/lesson manager 112 may speed up or slow down the proceeding speed of the repertory in accordance with the inferred speed to match the motion speed of the user with the proceeding speed of the repertory.

In the meantime, the game/lesson manager 112 of the motion based game/lesson device 110 stores and manages the history of the game or the lesson of the user in a predetermined storage unit as a personal profile to provide various community services and be utilized to improve personal motion lesson effect. For example, the game/lesson manager 112 may store and manage a history of a performance score and level information of the user for performing a game or lesson in a personal profile.

The game/lesson manager 112 may transmit the personal profile to the motion based game/lesson server 120. The service manager 121 of the motion based game/lesson server 120 stores and manages the personal profile information for every user in the repertory database 122 and provides a total game ranking between users based on the personal profile data or shares result information to provide various online community services. Such a service may include a service which recommends similar repertories to the user based on a repertory of a game which is frequently played or a lesson frequently taken by the user, a service which evaluates a motion ability of the user based on a distribution of motions which are satisfactorily performed by the user and motions which are unsatisfactorily performed and recommends a motion or a repertory in accordance with the level of the user, and a service which adjusts a lesson schedule for the user to intensively and repeatedly takes the lesson of motions which are unsatisfactorily performed by the user.

In the meantime, many of the user's motions may include movement of the user or a traffic line moving up and down and left and right. For example, the service manager 121 detects the motion or movement of the user in accordance with obtained video and depth information and precisely analyzes accuracy of the motion in consideration with the traffic line. The positional movement of the user may be configured by X axis and Y axis directions on a two-dimensional plane formed in a direction of looking down the user from the top. The positional movement of the user may be measured within a viewing angle using a camera which may detect a depth of the motion detecting sensor 102, so that the accuracy of the traffic line may be determined using position information of the user detected in real time. It is natural that each motion track 310 of the repertory data may include not only motion track information for every body part but also position information of a member on the two-dimensional plane space in order to calculate accuracy of the motion including the positional movement. The position information of the user may be displayed as relative position information with respect to an initial position.

For example, the motion detecting sensor 102 may detect a plane having a width, and a length of 3 mm, respectively with a resolution in the unit of 30 cm and the position of the user may be represented by a predetermined coordinate system (for example, six pixels*six pixels) on the space. In this case, not only the initial position of the human but also positional movement in accordance with the proceeding of the motion track is represented on the coordinate and the positional movement pattern forms an arbitrary trace on the coordinate system. When it is assumed that the positional movement of the user is performed in the order of (1, 0)->(2, 1)->(3, 1)->(3, 0) on an xy plane in accordance with the positional movement representing method, the positional movement sequence which is included in the motion track of the repertory data may be represented by a relative movement value with respect to the previous position such as (1, 0)->(+1, +1)->(+1, 0)->(0,−1). Since such a relative position representing method operates less dependently on the resolution of the depth detecting sensor, a spatial structure, and an initial position of the user, the method may be more advantageously utilized to determine accuracy of the choreography including the positional movement.

The user may momentarily depart from a depth detecting range of the motion detecting sensor 102 due to the positional movement sequence included in the motion track 310. In this case, since the motion cannot be detected, it is difficult to analyze the accuracy of the motion or reliability of the analysis result is lowered. According to the exemplary embodiment of the present invention, the depth detecting sensor (or a camera) of the motion detecting sensor 102 is mounted on a rotatable driving device and when the user is close to a boundary of an upper limit and a lower limit of the detecting range, the driving device in which the sensor is mounted rotates by a predetermined amount toward the user to stably evaluate the motion of the user.

In the meantime, according to the exemplary embodiment of the present invention, biomechanics information may be additionally added to the repertory data 131. The biomechanics information is included in the meta information track 313 of the motion track 310 or stored in the motion track by creating a separate information track. Representative contents of the biomechanics information may be calories consumption for every unit of motion. To this end, when a job such as motion capture is performed in order to manufacture the motion track 310, sensor devices which measure biomechanics information such as force and acceleration are mounted in each part of the body of the human who performs the motion to collect data. The calorie consumption of the motion may be calculated based on the data.

Therefore, when the use selects the motion track to perform the game or the lesson, the game/lesson manager 112 of the motion based game/lesson device 110 may calculate a similarity for the motion of the user and predict an actual calorie consumption of the user based on the calorie consumption which is attached to the motion. For example, when it is recorded that the user's motion shows 80% of a similarity with the reference motion for every unit of motion and 10 calories are consumed to perform the reference motion, the calorie consumption of the user is predicted to be 10*0.8=8 calories. According to the method depending on accuracy, the calorie consumption may not exactly match the actual calorie consumption of the user, but the method may be utilized to predict an approximate consumption.

More simply, the game/lesson manager 112 arithmetically calculates an exercising amount such as an average movement distance for every body part in a time interval of the unit of motion when the user performs the motion and compares the exercising amount with a threshold value to calculate the motion performance rate (similarity) as a percentage and multiplies the motion performance rate and the calorie consumption of the reference motion to calculate the calorie consumption due to the user's motion. As described above, the biomechanics information is utilized, so that the game/lesson manager 112 consistently predicts the calorie consumption of the user and stores and manages the calorie consumption in the personal profile. The game/lesson manager 112 manages a user personal exercising amount by the calorie consumption stored in the personal profile to help health promotion of the user.

On the other hand, according to the exemplary embodiment of the present invention, not only an expert, but also the user may create and distribute the repertory data. A professional group collects the motion data based on the motion capture technique and creates repertory data to transmit the repertory data to the motion based game/lesson server 120 on the online network through the motion based game/lesson publishing device 130, thereby distributing the repertory data. The service manager 121 acquires information on the repertory which is distributed to the motion based game/lesson servers 120 or searches, finds, and requests the distributed repertory to receive the repertory, so that the distributed repertory data is provided to the user to be utilized.

In the exemplary embodiment of the present invention, the user uses the motion based game/lesson device 110 to distribute his/her own history in accordance with the performing of the game or lesson, that is, the motion (result) data to the motion based game/lesson server 120. When the user selects the repertory to progress the game or the lesson, the game/lesson manager 112 consistently records the motion information of the user in the storage unit. In this case, the recorded data may include an end point coordinate of a skeleton joint and a coordinate of an intersecting point of joints as whole body skeleton data. The data recorded as described above needs to be easily reused and modified. When the user repeats the same repertory, the game/lesson manager 112 records and manages all of them. The game/lesson manager 112 provides the repertory distributing function to the menu to allow the user to select the menu. When the user selects the distribution, the game/lesson manager 112 collects the motion data of the user which is consistently recorded and stored to create one motion track 310 of the user in the repertory and transmit the motion track to the motion based game/lesson server 120 to be distributed.

Information on the user may be recorded in the meta information 301 of the motion track which is created by the user. The repertory data including the motion track which is distributed by the user is also transmitted to the users in the same way as the repertory data which is distributed by the professional group to be utilized in the game or the lesson. When the motion data of the user is collected, the game/lesson manager 112 selects and combines record data whose accuracy is highest for every motion section to configure the highest quality of motion track.

In the exemplary embodiment of the present invention, the user may create and distribute a new repertory including the motion track. To this end, the game/lesson manager 112 provides the repertory creating function as a menu. The user selects the repertory creating function and selectively designates the music track. The music track may be a music track which is received from a sound source which is possessed by the user or the server 120. Next, the user progresses the repertory and performs the motion and the game/lesson manager 112 records the motion data of the user and stores the motion data in the motion track to be formatted as a repertory. The user designates a part of the section of the motion track to be generated to create the motion track to repeat only the motion in the section. Unwanted motion is corrected therethrough. Further, the user may record various meta information 300 in the repertory data which is created by using an editing unit.

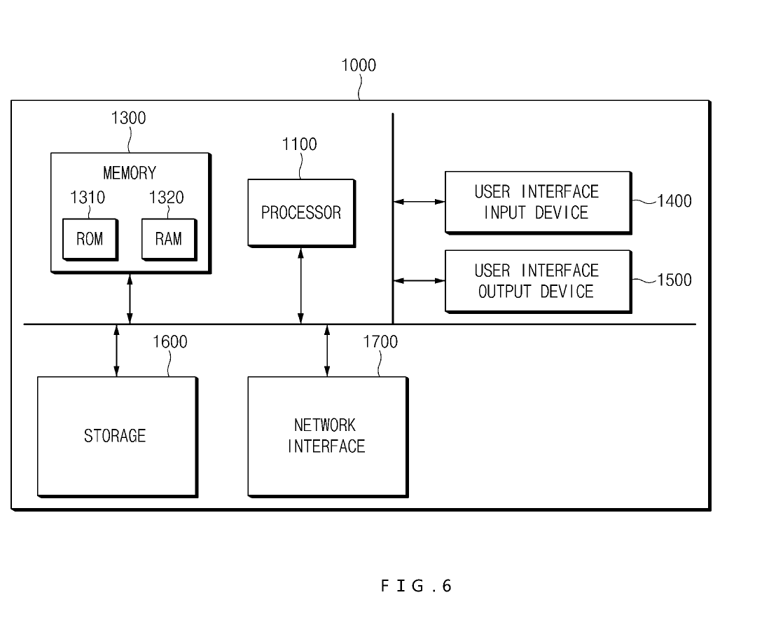

FIG. 6 is a view explaining an example of an implementing method of a motion based interactive service system 100 according to an exemplary embodiment of the present invention. A motion based game/lesson device 110, a motion based game/lesson server 120, and a motion based game/lesson publishing device 130 of a motion based interactive service system 100 according to an exemplary embodiment of the present invention may be configured by hardware, software, or a combination thoseof. For example, the motion based game/lesson device 110, the motion based game/lesson server 120, and the motion based game/lesson publishing device 130 may be implemented by a computing system 1000 of FIG. 6.

The computing system 1000 may include at least one processor 1100, a memory 1300, a user interface input device 1400, a user interface output device 1500, a storage 1600, and a network interface 1700 which are connected to each other through a bus 1200. The processor 1100 may be a semiconductor device which performs processings on commands which are stored in a central processing unit (CPU), or the memory 1300 and/or the storage 1600. The memory 1300 and the storage 1600 may include various types of volatile or non-volatile storage media. For example, the memory 1300 may include a read only memory (ROM) and a random access memory (RAM).

The method or a step of the method or algorithm which has described regarding the exemplary embodiments disclosed in the specification may be directly implemented by a hardware or software module which is executed by the processor 1100 or a combination thereof. The software module may be stored in a storage medium (that is, the memory 1300 and/or the storage 1600) such as a RAM, a flash memory, a ROM, an EPROM, an EEPROM, a register, a hard disk, a detachable disk, or a CD-ROM. An exemplary storage medium is coupled to the processor 1100 and the processor 1100 may read information from the storage medium and write information in the storage medium. As another method, the storage medium may be integrated with the processor 1100. The processor and the storage medium may be stored in an application specific integrated circuit (ASIC). The ASIC may be stored in a user terminal. As another method, the processor and the storage medium may be stored in a user terminal as individual components.

As described above, according to the motion based interactive service system 100 according to the present invention, the user may easily and efficiently enjoy the motion based performance or take a lesson by various methods such as a dance game or dance lesson. Therefore, a new service industry such as a dance practicing center through the online network is created and users create, share, and distribute various motion data, so that it is expected that an additional market is formed. Further, applications or services of the related art do not provide a method of selecting a motion and taking a lesson, but according to the present invention, the user easily selects the motion and takes a lesson. For example, in dance games of the related art, the user selects a song, the user dances the choreographic motion while playing the song from the start to the end and then a total score is provided. In contrast, according to the present invention, when the user wants, the user may select and play a part of the entire choreography which configures the song and take a lesson while moving only a part of a body part. Further, also in the motion recognition based games of the related art, a method of evaluating a quality of the motion performed by the user is included and a unit which provides a lesson for the motion to the user based on the method is provided, but in the method of the related art, the lesson procedure is simple and feedback for the user's motion is not sufficient, so that the efficiency of the lesson is lowered. In contrast, the present invention suggests a method of efficiently and specifically providing a lesson of a complex motion by improving a feedback method, a lesson procedure management, and an interaction interface configuration.

A choreographic motion evaluating method in which positional movement accompanied with the choreography according to the present invention is considered copes with change of a formation of a group dance performed by a plurality of members, so that more various choreographies are accepted to provide various interactive services. Further, a database including biomechanics information according to the present invention is utilized, so that the calorie consumption of the user is more precisely predicted and the database is utilized for the health management of the user. According to the present invention, performance data such as choreography is supplied and distributed through the online server, so that the information is shared and participation of the users is more actively induced.

The specified matters and limited exemplary embodiments and drawings such as specific elements in the present invention have been disclosed for broader understanding of the present invention, but the present invention is not limited to the exemplary embodiments, and various modifications and changes are possible by those skilled in the art without departing from an essential characteristic of the present invention. Therefore, the spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. An interactive service method in a user motion based interactive service device for a repertory which is executed through a display screen, the method comprising:
executing a repertory which is selected by a user through a display screen so that sequential motions in accordance with reference motion data of the repertory data are displayed on the display screen and receiving a video and depth information of a motion of the user obtained by a motion detecting sensor to convert the video and the depth information into comparison target input data;
extracting first skeleton data including an end point of a skeleton joint or a coordinate value for a joint or an angle of the skeleton joint for the motion of the user from the comparison target input data and comparing the first skeleton data with second skeleton data included in the reference motion data to evaluate a similarity of temporal or spatial consistency; and
providing feedback of an evaluation result in accordance with the evaluation back to the display screen.

2. The interactive service method of claim 1, wherein the reference motion data includes repertory meta information, a plurality of motion tracks as the reference motion data for one or more members which are displayed on the display screen, and a music track including music information.

3. The interactive service method of claim 2, wherein with respect to the repertory selecting any one of the plurality of members displayed on the display screen, the motion track includes a body part track including a coordinate value for an end point or a joint of a skeleton joint of the member or an angle of the skeleton joint and a meta information track including a name of a motion for every time period, importance of the motion, importance for every body part, or difficulty of the motion.

4. The interactive service method of claim 1, wherein the providing of feedback includes providing feedback by dividing the evaluation result in accordance with a similarity for temporal or spatial consistency for every body part with the reference motion data for a motion of the user and display the result on the display screen in accordance with a divided displaying method or provide the feedback of the result by a voice through a speaker.

5. The interactive service method of claim 1, wherein the providing of feedback includes overlapping the motion of the user on a character which performs the reference motion in accordance with the reference motion data as silhouettes to display the motion of the user on the display screen.

6. The interactive service method of claim 1, wherein the providing of feedback includes dividing the motion of the user in accordance with a level of the similarity for every unit of motion to display the motion in different regions of the display screen by an icon.

7. The interactive service method of claim 1, further comprising:
analyzing the reference motion data to display, on the display screen, a motion configuring map which represents a section of a sequential time line structure for every unit of motion, motion track meta information including a fluctuation graph which represents importance for every motion section represented on the motion configuring map, or a set of icons which are selected by the user so as to display the summarized information for every motion section and enable a game or a lesson for every motion section.

8. The interactive service method of claim 1, further comprising:
calculating calorie consumption in accordance with the similarity in accordance with the motion of the user using biomechanics information included in the repertory data and displaying the calorie consumption for the motion of the user on the display screen.

9. The interactive service method of claim 1, wherein the repertory data is managed and provided by the interactive service device, or provided through a server on a network which receives the repertory data through an external game/lesson publishing device on-line, or a motion performing result in accordance with the game or the lesson for the repertory of users is provided to the server as a personal profile and then provided by the server on-line.

10. An interactive service system for a user motion based interactive service for a repertory which is executed through a display screen, the system comprising:
a game/lesson manager which executes a sequential motion in accordance with reference motion data of repertory data for a repertory selected by a user through a display screen to be displayed on the display screen; and
a video processing manager which receives a video and depth information for a motion of the user obtained by a motion detecting sensor and converts the video and the depth information into comparison target input data,
wherein the game/lesson manager extracts first skeleton data including an end point of a skeleton joint or a coordinate value for a joint or an angle of the skeleton joint for the motion of the user from the comparison target input data and compares the first skeleton data with second skeleton data included in the reference motion data to evaluate a similarity of temporal or spatial consistency, and provides feedback of the evaluation result in accordance with the evaluation to the display screen.

11. The interactive service system of claim 10, wherein the reference motion data includes repertory meta information, motion tracks as the reference motion data for one or more members which are displayed on the display screen, and a music track including music information.

12. The interactive service system of claim 11, wherein for the repertory of selecting any one of the plurality members displayed on the display screen, the motion track includes a body part track including a coordinate value for an end point or a joint of a skeleton joint of the member or an angle of the skeleton joint and a meta information track including a name of a motion for every time period, importance of the motion, importance for every body part, or a difficulty of the motion.

13. The interactive service system of claim 10, wherein the game/lesson manager provides feedback by dividing the evaluation result in accordance with a similarity for temporal or spatial consistency for every body part with the reference motion data for a motion of the user and displays the result on the display screen by the divided displaying method or provides feedback of the result by a voice through a speaker.

14. The interactive service system of claim 10, wherein the game/lesson manager overlaps the motion of the user on a character which performs the reference motion in accordance with the reference motion data as silhouettes to display the motion of the user on the display screen.

15. The interactive service system of claim 10, wherein the game/lesson manager divides the motion of the user in accordance with a level of the similarity for every unit of motions to display the motion in different regions of the display screen by an icon.

16. The interactive service system of claim 10, wherein the game/lesson manager analyzes the reference motion data to display, on the display screen, a motion configuring map which represents a section of a sequential time line structure for every unit of motion, motion track meta information including a fluctuation graph which represents importance for every motion section represented on the motion configuring map, or a set of icons which are selected by the user so as to display the summarized information for every motion section and enable a game or a lesson for every motion section.

17. The interactive service system of claim 10, wherein the game/lesson manager calculates the calorie consumption in accordance with the similarity in accordance with the motion of the user using biomechanics information included in the repertory data and displays the calorie consumption for the motion of the user on the display screen.

18. The interactive service system of claim 10, wherein the repertory data is managed and provided by the interactive service device, or provided through a server on a network which receives the repertory data through an external game/lesson publishing device on-line, or a motion performing result in accordance with the game or the lesson for the repertory of the users is provided to the server as a personal profile and then provided by the server on-line.
